(19) United States
(12) Patent Application Publication
(10) Pub. No.: US 2025/0382542 A1
(43) Pub. Date: Dec. 18, 2025

(54) APPARATUS FOR PRODUCING CANDLES

(71) Applicant: Herrhammer GmbH Spezialmaschinen, Ochsenfurt (DE)

(72) Inventors: Ralf DIEßLIN, Würzburg (DE); Jonas HARDUNG, Iphofen-Dornheim (DE); Christian GEBAUER, Marktbreit (DE)

(73) Assignee: Herrhammer GmbH Spezialmaschinen, Ochsenfurt (DE)

(21) Appl. No.: 18/877,323

(22) PCT Filed: Jun. 21, 2023
(86) PCT No.: PCT/EP2023/066837

§ 371 Date: Dec. 20, 2024

(30) Foreign Application Priority Data
Jul. 7, 2022 (DE) 10 2022 116 922.7

(51) Int. Cl. C11C 5/02

(52) U.S. Cl. CPC C11C 5/023

(57) ABSTRACT

An apparatus for producing candles from a liquid or pasty raw material. The apparatus for producing candles includes a raw material supply line, an outlet, through which the liquid or pasty raw material can be dispensed in order to fill a candle container and/or the liquid or pasty raw material can be withdrawn from the candle container by suction, and a metering device that has a housing with an inflow and outflow. The inflow is fluidically connected to the raw material supply line and the outflow is fluidically connected to the outlet, and the liquid or pasty raw material can be dispensed and/or withdrawn by suction through the outlet in a metered manner with the aid of the metering device. At least two mutually intermeshing gearwheels are accommodated within the housing of the metering device.

### FIELD

The present invention pertains to an apparatus for producing candles from a liquid or pasty raw material.

### BACKGROUND

Various methods for producing candles are known from the prior art. For example, candles can be produced by using filling or casting methods. To this end, liquid wax or pasty candle raw material is initially filled into a container that may be made of glass, plastic, metal or another suitable material. Piston pumps or gravity fillers are traditionally used for introducing the liquid or pasty raw material into the candle container. The liquid or pasty raw material can be filled into the candle container in a metered manner depending on the operating mode of the piston pump or the size of the outlet opening of the gravity filler. However, both solutions typically require an intermediate tank that provides a sufficiently large supply of liquid or pasty raw material for allowing the candle production process to run continuously. A closing valve has to be provided at the outlet downstream of the piston pump or the gravity filler in order to stop the supply of raw material as soon as the candle container is filled with the raw material to the desired level.

### SUMMARY

The present invention is based on the objective of reducing or even eliminating the disadvantages known from the prior art. The present invention particularly aims to make available an apparatus for producing candles, which allows better metering of the liquid or pasty raw material during the filling process and also has fewer components such that it is more cost-effective and easier to clean.

This objective is attained with an apparatus for producing candles from a liquid or pasty raw material that comprises a raw material supply line, an outlet, through which the liquid or pasty raw material can be dispensed in order to fill a candle container and/or the liquid or pasty raw material can be withdrawn from the candle container by suction, and a metering device that has a housing with an inflow and outflow. The inflow is fluidically connected to the raw material supply line and the outflow is fluidically connected to the outlet. The liquid or pasty raw material can be dispensed and/or withdrawn by suction through the outlet in a metered manner with the aid of the metering device. According to the invention, at least two mutually intermeshing gearwheels are accommodated within the housing of the metering device.

The at least one gearwheel preferably can be driven by means of a drive shaft.

It is even more preferable that both gearwheels have a spur gearing.

It is furthermore preferred that the metering device is an external gear pump.

It is likewise advantageous that the gearwheels of the metering device can be heated.

According to a preferred embodiment of the invention, the housing of the metering device and the outlet are realized in one piece.

It is likewise preferred that the outlet corresponds to the outflow of the metering device.

It is furthermore advantageous that an outlet opening of the outlet is arranged in a horizontal plane.

It is even more preferable that the outlet has no valve.

According to another preferred embodiment of the invention, the raw material supply line is physically connected directly to the inflow of the metering device without an intermediate tank.

### BRIEF DESCRIPTION OF THE DRAWINGS

A preferred embodiment of the invention is described below purely by way of example with reference to the attached drawing. In this drawing:

FIG. 1 shows an apparatus for producing a candle from a liquid or pasty material according to a preferred embodiment of the invention.

### DETAILED DESCRIPTION

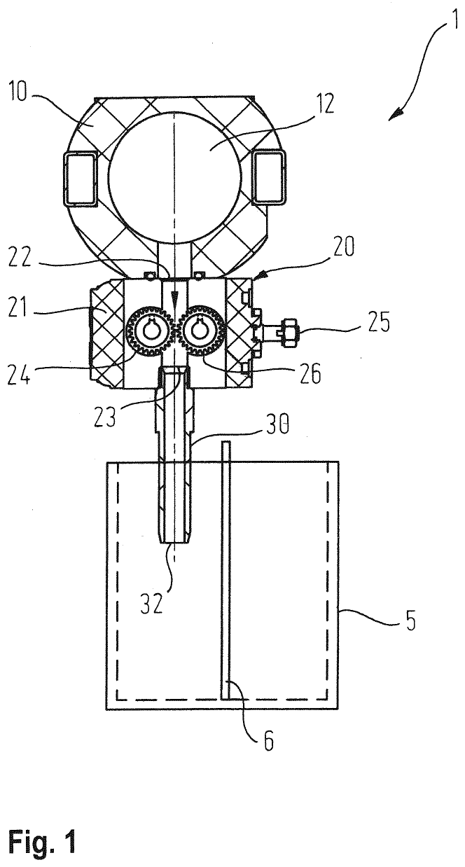

The apparatus for producing candles illustrated in FIG. 1 basically makes it possible to fill all known candle molds and containers, i.e. everything from small tea light candles to large candles with a volume of more than 5 l.

Any liquid or pasty raw materials such as paraffin wax, stearin waxes, palm wax or beeswax can be used as raw material for the production of candles.

The apparatus 1 for producing candles illustrated in FIG. 1 comprises a material supply line 10 that defines a lumen 12, through which the liquid or pasty raw material can flow. In the case of filling the candle container 5, in which a wick 6 may also be arranged, a metering device 20 having a housing 21 with an inflow 22 and an outflow 23 is located downstream of the material supply line 10. Two mutually intermeshing gearwheels 24, 26 are arranged within the housing 21. At least one of the gearwheels 24, 26 can be driven by means of a drive shaft 25 that preferably is arranged horizontally. However, it is also conceivable that both gearwheels 24, 26 can be respectively driven by means of a drive shaft or a common drive shaft 25. It is furthermore conceivable to heat the gearwheels 24, 26 in order to maintain the viscosity and therefore the flow rate of the liquid or pasty raw material at a certain value.

The metering device 20 illustrated in FIG. 1 is in external gear pump, in which both gearwheels 24, 26 have a spur gearing. An internal gear pump or even a so-called annular gear pump of the Eaton type may also be used alternatively to an external gear pump. It is also conceivable to use a screw pump, in which two helical gearwheels rotate in opposite directions.

The outflow 23 of the metering device 20 is physically connected to an outlet nozzle 30. The outlet nozzle 30 extends into the candle container 5 while filling is carried out in order to thereby simplify the filling process. The plane of the outlet opening 32 of the outlet nozzle 30 preferably is arranged horizontally in order to simplify the filling process of the candle container 5 by using gravity.

However, the apparatus 1 illustrated in FIG. 1 not only makes it possible to fill the candle container 5, but also to withdraw liquid or pasty raw material from the candle container 5 by suction. This is particularly advantageous, for example, in the production of hollow wax shapes, in which residual liquid wax should be removed by suction after a brief cooling period such that a wax wall with cavity remains. To this end, the metering device 20 merely needs to be temporarily operated in the opposite direction, i.e. one of the gearwheels 24, 26 is rotated in the opposite direction referred to the filling process.

High metering accuracies and repeat accuracies can be achieved depending on the choice of the gearwheel geometry because the apparatus 1 illustrated in FIG. 1 operates due to its constructive design independently of hydrostatic pressure, which can predominate in a gravity filler, and the risk of creating a vacuum, which can arise in a piston pump. In comparison with a piston pump or a gravity filler, the outlet nozzle 30 can also operate without restrictions on volume. A continuous filling process can therefore be realized.

A variable filling rate can be achieved because the rotational speed, with which one of the gearwheels 24, 26 is driven, can be freely adjusted or chosen with the rotational speed of the drive shaft 25. This also provides significant advantages in comparison with conventional piston pumps, in which the last wax has to be ejected with high speeds and a high surface pressure. The entire filling process can therefore be carried out cleaner because no splattering of costly raw material takes place.

Due to its constructive design, the gear pump 20 likewise inhibits the continued flow of raw material from the outlet 32 such that no additional closing valve is required in the region of the outlet 32. In order to completely disable any continued dripping of raw material from the outlet 32, the apparatus 1 can also be briefly operated in the opposite direction after the filling process is completed. In this way, raw material can be moved back into the outlet nozzle 30.

The outlet 32 may correspond to the outflow 23 of the metering device 20 depending on the chosen geometry of the housing 21 of the metering device 20. This would eliminate the need for an outlet nozzle 30 of the type illustrated in FIG. 1.

1-10. (canceled)

11. An apparatus for producing candles from a liquid or pasty raw material, comprising:
a raw material supply line,
an outlet, through which the liquid or pasty raw material can be dispensed in order to fill a candle container and/or the liquid or pasty raw material can be withdrawn from the candle container by suction, and
a metering device that has a housing with an inflow and outflow, wherein the inflow is fluidically connected to the raw material supply line and the outflow is fluidically connected to the outlet, and wherein the liquid or pasty raw material can be dispensed and/or withdrawn by suction through the outlet in a metered manner with the aid of the metering device,
wherein at least two mutually intermeshing gearwheels are accommodated within the housing of the metering device.

12. The apparatus for producing candles according to claim 11, wherein at least one gearwheel can be driven by means of a drive shaft.

13. The apparatus for producing candles according to claim 11, wherein both gearwheels have a spur gearing.

14. The apparatus for producing candles according to claim 11, wherein the metering device is an external gear pump.

15. The apparatus for producing candles according to claim 11, wherein the gearwheels of the metering device can be heated.

16. The apparatus for producing candles according to claim 11, wherein the housing of the metering device and the outlet are realized in one piece.

17. The apparatus for producing candles according to claim 11, wherein the outlet corresponds to the outflow of the metering device.

18. The apparatus for producing candles according to claim 11, wherein an outlet opening of the outlet is arranged in a horizontal plane.

19. The apparatus for producing candles according to claim 11, wherein the outlet has no valve.

20. The apparatus for producing candles according to claim 11, wherein the raw material supply line is physically connected directly to the inflow of the metering device without an intermediate tank.
